(19) United States
(12) Patent Application Publication
(10) Pub. No.: US 2025/0321317 A1
(43) Pub. Date: Oct. 16, 2025

(54) FULL-POLARIMETRIC RADAR

(71) Applicant: NATIONAL TAIWAN UNIVERSITY, Taipei City (TW)

(72) Inventors: YI-CHENG LIN, Taipei City (TW); TZU-MING HUANG, Taipei City (TW)

(21) Appl. No.: 18/779,057

(22) Filed: Jul. 21, 2024

(30) Foreign Application Priority Data
Apr. 15, 2024 (TW) 113113890

(51) Int. Cl. G01S 7/02; G01S 7/03; G01S 13/00

(52) U.S. Cl. CPC G01S 7/024; G01S 7/025; G01S 7/026; G01S 7/03; G01S 13/003

(57) ABSTRACT

A full-polarimetric radar is provided. The fully polarimetric includes a first dual-polarized antenna module, a second dual-polarized antenna module and an antenna control circuit. The first dual-polarized antenna module includes a first polarized antenna and a second polarized antenna that are orthogonal to each other. The second dual-polarized antenna module includes a third polarized antenna and a fourth polarized antenna that are orthogonal to each other. The antenna control circuit is configured to control two mutually orthogonal ones of the first through the fourth polarized antennas to radiate a first transmitting signal and a second transmitting signal at a first time point and a second time point, respectively, and receive a first reflecting signal, a second reflecting signal, a third reflecting signal and a fourth reflecting signal through another two mutually orthogonal ones of the first through the fourth polarized antennas, and generate a detection result.

### CROSS-REFERENCE TO RELATED PATENT APPLICATION

This application claims the benefit of priority to Taiwan Patent Application No. 113113890, filed on Apr. 15, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a radar, and more particularly to a full-polarimetric radar.

### BACKGROUND OF THE DISCLOSURE

Existing multi-antenna radar technologies are all composed of same-polarized antennas, which have an issue of being unable to receive cross-polarization signals. Therefore, providing a radar capable of receiving cross-polarization signals for overcoming the above-mentioned disadvantage through improvement of antenna design and transceiver mechanism has become one of the important issues to be addressed in the related art.

### SUMMARY OF THE DISCLOSURE

In response to the above-referenced technical inadequacies, the present disclosure provides a full-polarimetric radar capable of transmitting and receiving cross-polarization signals.

In order to solve the above-mentioned problems, one of the technical aspects adopted by the present disclosure is to provide a full-polarimetric radar, which includes a first dual-polarized antenna module, a second dual-polarized antenna module and an antenna control circuit. The first dual-polarized antenna module includes a first polarized antenna and a second polarized antenna, the first polarized antenna has a first polarization port, the second polarized antenna has a second polarization port, and polarization directions of the first polarized antenna and the second polarized antenna are orthogonal to each other. The second dual-polarized antenna module includes a third polarized antenna and a fourth polarized antenna, the third polarized antenna has a third polarization port, the fourth polarized antenna has a fourth polarization port, and polarization directions of the third polarized antenna and the fourth polarized antenna are orthogonal to each other. The antenna control circuit is electrically connected to the first polarization port, the second polarization port, the third polarization port, and the fourth polarization port, and the antenna control circuit is configured to: control two mutually orthogonal ones of the first polarized antenna, the second polarized antenna, the third polarized antenna, and the fourth polarized antenna to radiate a first transmitting signal and a second transmitting signal that are mutually orthogonal at a first time point and a second time point, respectively; receive a first reflecting signal and a second reflecting signal that correspond to the first transmitting signal, and a third reflecting signal and a fourth reflecting signal that correspond to the second transmitting signal through another two mutually orthogonal ones of the first polarized antenna, the second polarized antenna, the third polarized antenna, and the fourth polarized antenna; and generate a detection result according to the first reflecting signal, the second reflecting signal, the third reflecting signal and the fourth reflecting signal.

In order to solve the above-mentioned problems, one of the technical aspects adopted by the present disclosure is to provide a full-polarimetric radar, which includes a plurality of dual-polarized antenna modules and at least one antenna control circuit. The plurality of dual-polarized antenna modules each includes a first polarized antenna and a second polarized antenna, the first polarized antenna has a first polarization port, the second polarized antenna has a second polarization port, and polarization directions of the first polarized antenna and the second polarized antenna are orthogonal to each other. The at least one antenna control circuit is electrically connected to the first polarization port and the second polarization port of each of the plurality of dual-polarized antenna modules, and the at least one antenna control circuit is configured to: control the plurality of dual-polarized antenna modules to radiate a first transmitting signal and a second transmitting signal; receive a first reflecting signal and a second reflecting signal that correspond to the first transmitting signal, and a third reflected signal and a fourth reflected signal that correspond to the second transmitted signal through the plurality of dual-polarized antenna modules; and generate a detection result according to the first reflecting signal, the second reflecting signal, the third reflecting signal and the fourth reflecting signal that are received.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a functional block diagram of a full-polarimetric radar according to a first embodiment of the present disclosure;

FIG. 2 is a side view of a dual-polarized cavity-backed antenna module according to the first embodiment of the present disclosure;

FIGS. 3A to 3D are respectively top views of first to fourth metal layers of the dual-polarized cavity-backed antenna module according to the first embodiment of the present disclosure;

FIG. 4 is a top view of the full-polarimetric radar according to the first embodiment of the present disclosure;

FIG. 5 is a side view of the full-polarimetric radar according to the first embodiment of the present disclosure;

FIG. 6 is a schematic diagram of a monostatic radar configuration according to the first embodiment of the present disclosure;

FIG. 7 is a timing diagram showing an antenna control circuit controlling the full-polarimetric radar to transmit and receive signals in a time-divisionally duplexing manner according to the first embodiment of the present disclosure;

FIG. 8 is a schematic diagram of signal processing performed by the antenna control circuit according to the first embodiment of the present disclosure;

FIG. 9 is a schematic diagram of a bistatic radar configuration according to the first embodiment of the present disclosure;

FIG. 10 is a configuration diagram of a full-polarimetric radar according to a second embodiment of the present disclosure;

FIG. 11 is a schematic diagram of a configuration of a full-polarimetric radar for generating positive and negative 45-degree polarization signals according to the second embodiment of the present disclosure; and

FIG. 12 is a schematic diagram of a configuration of a full-polarimetric radar for generating left-handed circular polarization signals and right-handed circular polarization signals according to the second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

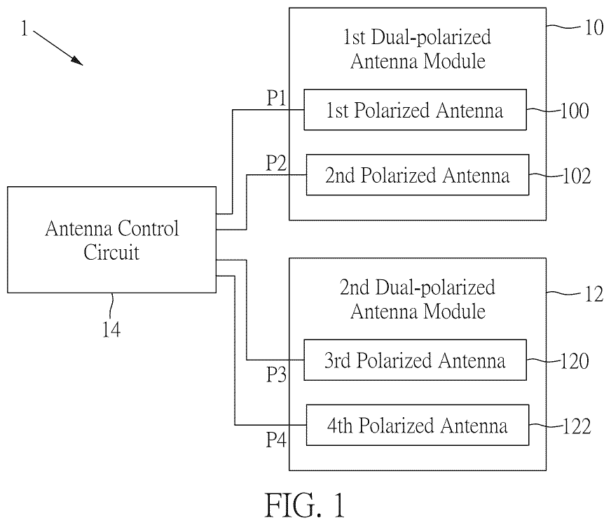

FIG. 1 is a functional block diagram of a full-polarimetric radar according to a first embodiment of the present disclosure. Referring to FIG. 1, the present disclosure provides a full-polarimetric radar 1 including a first dual-polarized antenna module 10, a second dual-polarized antenna module 12 and an antenna control circuit 14.

The first dual-polarized antenna module 10 includes a first polarized antenna 100 and a second polarized antenna 102. The first polarized antenna 100 has a first polarization port P1, the second polarized antenna 102 has a second polarization port P2, and polarization directions of the first polarized antenna 100 and the second polarized antenna 102 are orthogonal to each other.

Similarly, the second dual-polarized antenna module 12 includes a third polarized antenna 120 and a fourth polarized antenna 122. The third polarized antenna 120 has a third polarization port P3, and the fourth polarized antenna 122 has a fourth polarization port P4. Polarization directions of the third polarized antenna 120 and the fourth polarized antenna 122 are orthogonal to each other.

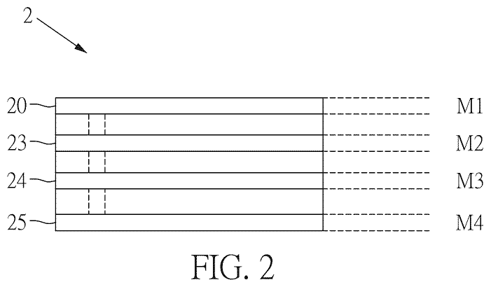

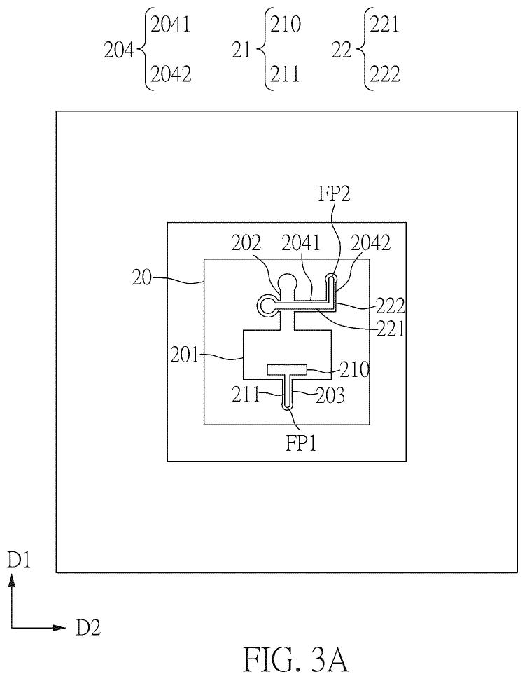

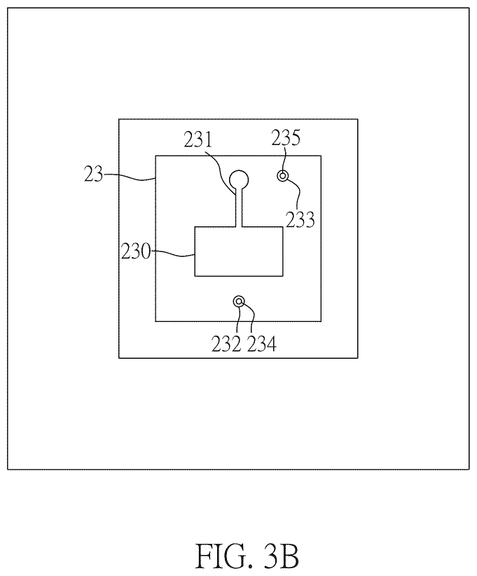

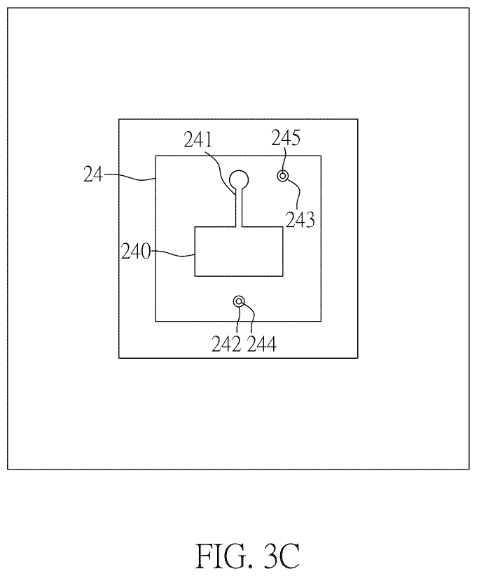

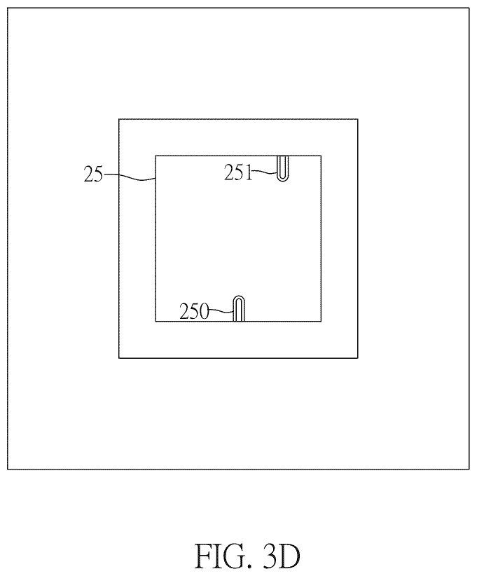

It should be noted that the first dual-polarized antenna module 10 and the second dual-polarized antenna module 12 can each be a dual-polarized cavity-backed antenna module. Referring to FIGS. 2 and 3A to 3D, FIG. 2 is a side view of a dual-polarized cavity-backed antenna module according to the first embodiment of the present disclosure, and FIGS. 3A to 3D are respectively top views of first to fourth metal layers of the dual-polarized cavity-backed antenna module according to the first embodiment of the present disclosure.

As shown in FIG. 2, the dual-polarized cavity-backed antenna module 2 can be disposed in a substrate having four metal layers, and dielectric layers and conductive vias for electrical connection can be disposed between two adjacent ones of the metal layers. The dual-polarized cavity-backed antenna module 2 includes a first metal member 20, a T-shaped metal member 21, a strip-shaped metal member 22, a second metal member 23, a third metal member 24 and a bottom metal member 25. The first metal member 20, the T-shaped metal member 21 and the strip-shaped metal member 22 are arranged in a first metal layer M1, the second metal member 23 is arranged in a second metal layer M2, the third metal member 24 is arranged in a third metal layer M3, and the bottom metal member 25 is arranged in a fourth metal layer M4. It should be noted that inclusion of the third metal member 24 is for exemplary purposes only, and the dual-polarized cavity-backed antenna module 2 can operate normally without the third metal member 24. That is to say, the dual-polarized cavity-backed antenna module 2 can only include the first metal layer M1, the second metal layer M2 and the fourth metal layer M4.

Referring to FIG. 3A, the first metal member 20 is a rectangular metal member having a first opening 201 and a first strip-shaped slot 202 and a second strip-shaped slot 203 extending outwardly from two opposite sides of the first opening 201, and circular slots are respectively disposed at ends of the first strip-shaped slot 202 and the second strip-shaped slot 203. In a top view, the first opening 201 can be, for example, a rectangle, and two opposite edges of the rectangle in a first direction D1 are provided with the first strip-shaped slot 202 and the second strip-shaped slot 203 extending along the first direction D1. In addition, the first metal member 20 further has a third strip-shaped slot 204 intersecting with the first strip-shaped slot 202. The third strip-shaped slot 204 can be, for example, an L-shaped slot having a first portion 2041 and a second portion 2042, but the present disclosure is not limited thereto. The first portion 2041 is a strip-shaped slot, which extends along a second direction D2 and intersects with the first strip-shaped slot 202, and a circular slot is disposed at an end of the first portion 2041. The second portion 2042 is connected to the first portion 2041, and extends along the first direction D1 toward a direction away from the first opening 201. The second portion 2042 is shorter than the first portion 2041.

The T-shaped metal member 21 includes a main section 210 and a branch section 211 connected to each other. The branch section 211 is disposed in the second strip-shaped slot 203, and a first feeding terminal FP1 is disposed at an end of the branch section 211 that is not connected to the main section 210. It should be noted that the T-shaped metal member 21 is disposed in the first metal layer M1 similar to the first metal member 20, but is not connected to the first metal member 20. That is, an edge of the branch section 211 is separated from the edge of the second strip-shaped slot 203 by a predetermined distance. It should be noted that a microstrip-to-T-stub feeding structure is provided in this embodiment to serve as a polarized antenna (for example, a first polarized antenna or a third polarized antenna).

On the other hand, the strip-shaped metal member 22 is disposed in the third strip-shaped slot 204, and the strip-shaped metal member 22 can be, for example, an L-shaped metal member having a first portion 221 and a second portion 222 connected to each other, but the present disclosure is not limited thereto. The strip-shaped metal member 22 can only include a necessary component, such as the first portion 221, which can be, for example, a strip-shaped structure. The third strip-shaped slot 204 has a shape similar to an L-shape, and a first part 2041 of the third strip-shaped metal member 204 extends along the second direction D2. A part of the first portion 221 is located at an intersection between the third strip-shaped slot 204 and the first strip-shaped slot 202. In addition, a circular metal member is disposed at an end of the first portion 221 and is accommodated by the circular slot of the third strip-shaped slot 204. In addition, the strip-shaped metal member 22 can be optionally provided with a second portion 222 for adapting purposes. The second portion 222 extends along the first direction D1 in a direction away from the first opening 201, and the second portion 222 is shorter than the first portion 221. The strip-shaped metal member 22 has a second feeding terminal FP2 disposed at an end of the second portion 222 not connected to the first portion 221. It should be noted that a microstrip-to-slot feeding structure is formed to serve as another polarized antenna.

Referring to FIG. 3B, the second metal member 23 is disposed below the first metal member 20. The second metal member 23 is a rectangular metal member having a second opening 230 and a fourth strip-shaped slot 231, which positionally correspond to the first opening 201 and the first strip-shaped slot 202, respectively. That is, when the second metal member 23 overlaps with the first metal member 20, projections of the first opening 201 and the first strip slot 202 formed onto the second metal layer M2 overlap with the second opening 230 and the fourth strip-shaped slot 231, respectively, and the first opening 201 and the second opening 230 jointly form a back cavity. In addition, the second metal member 23 is also provided with circular slots 232, 233 and circular feeding metal members 234, 235 respectively located in the circular slots 232, 233 at positions corresponding to the first feeding terminal FP1 and the second feeding terminal FP2, such that positions where signals feed in can extend to the lower metal layers. It can be reasoned that the second metal member 23 and the first metal member 20 can be electrically connected through multiple conductive vias arranged between the first metal layer M1 and the second metal layer M2, the first feeding terminal FP1 can be electrically connected to the circular feeding metal member 234 through one of the conductive vias, and the second feeding terminal FP2 can be electrically connected to the circular feeding metal member 235 through another one of the conductive vias.

Referring to FIG. 3C, the third metal member 24 can be selectively disposed below the second metal member 23. The third metal member 24 is a rectangular metal member having a third opening 240 and a fifth strip-shaped slot 241, which positionally correspond to the second opening 230 and the fourth strip-shaped slot 231, respectively. The third metal member 24 is substantially similar to the second metal member 23. The third metal member 24 is also provided with circular slots 242, 243 and circular feeding metal members 244, 245 respectively located in the circular slots 242, 243 at positions corresponding to the first feeding terminal FP1 and the second feeding terminal FP2, such that positions where signals are fed in can extend to the lower metal layer. The third metal member 24 and the second metal part 23 can be electrically connected through multiple conductive vias disposed between the second metal layer M2 and the third metal layer M3, the circular feeding metal member 234 can be electrically connected to the circular feeding metal member 244 through one of the conductive vias, and the circular feeding metal member 235 can be electrically connected to the circular feeding metal member 245 through another one of the conductive vias. It should be noted that the third metal member 24 is merely an example, and the dual-polarized cavity-backed antenna module 2 can operate normally without the third metal member 24.

Referring to FIG. 3D, the bottom metal member 25 is disposed below the third metal member 24. The bottom metal member 25 is a rectangular metal member and has sixth strip-shaped slots 250 and 251 extending to an edge in the first direction D1. The sixth strip-shaped slots 250 and 251 positionally correspond to the circular slots 242 and 243 of the third metal component 24, respectively, and are used to lead signal feeding portions to the edge of the bottom metal member 25.

The first metal member 20, the second metal member 23, and the third metal member 24 are all electrically connected to the bottom metal component 25, and the first opening 201, the second opening 230 and the third opening 240 jointly form the back cavity. According to tests, the dual-polarized cavity-backed antenna module 2 can form a unidirectional radiation pattern above the first metal layer M1, and two orthogonal modes can also coexist in the back cavity while the dual-polarized cavity-backed antenna module 2 radiate signals in a vertical polarization direction and a horizontal polarization direction. Moreover, an isolation greater than 40 dB can be achieved within a frequency ranging from 56 to 67 GHz.

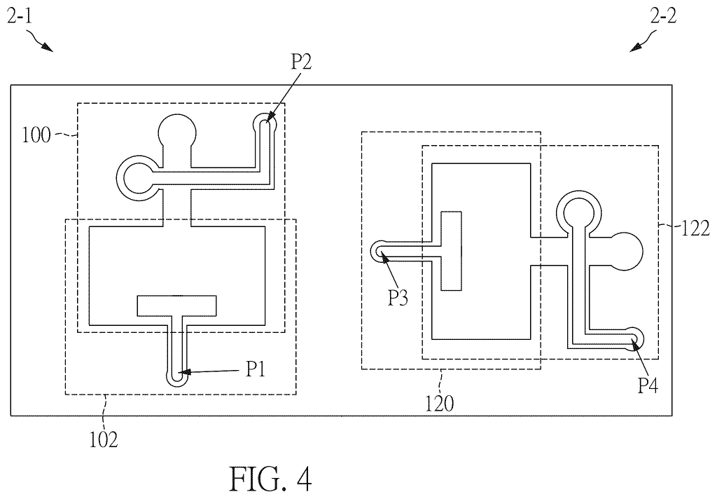

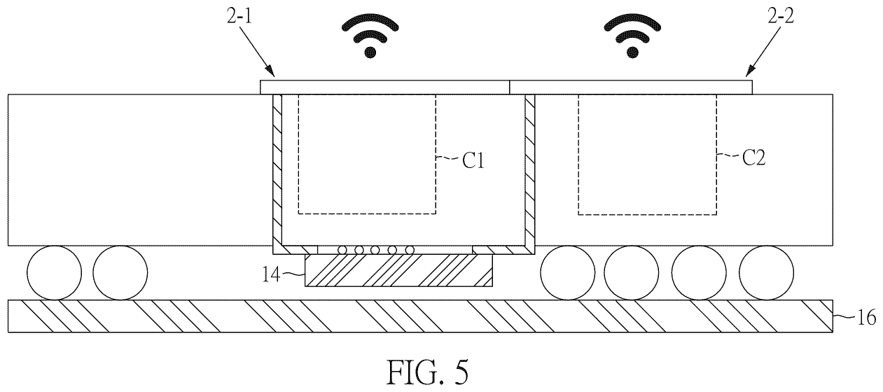

Referring to FIGS. 4 and 5, FIG. 4 is a top view of the full-polarimetric radar according to the first embodiment of the present disclosure, and FIG. 5 is a side view of the full-polarimetric radar according to the first embodiment of the present disclosure. In FIG. 4 and FIG. 5, the full-polarimetric radar 1 can include two adjacent dual-polarized cavity-backed antenna modules 2-1 and 2-2 arranged in different directions. Specifically, if a direction along which the first strip-shaped slot 202 and the second strip-shaped slot 203 extend in FIG. 3A (i.e., the first direction D1) are set as a configuration direction, the configuration directions of the dual-polarized cavity-backed antenna modules 2-1 and 2-2 are perpendicular to each other.

In addition, as can be seen from FIG. 5, the dual-polarized cavity-backed antenna modules 2-1 and 2-2 are disposed on the circuit board 16 and have a back cavity C1 and C2, respectively. The antenna control circuit 14 is disposed between the circuit board 16 and the dual-polarized cavity-backed antenna modules 2-1 and 2-2. It should be noted that the dual-polarized cavity-backed antenna module 2-1 corresponds to the first dual-polarized antenna module 10 and has the first polarized antenna 100 and the second polarized antenna 102 and the first polarization port P1 and the second polarization port P2 corresponding thereto; in addition, the dual-polarized cavity-backed antenna module 2-1 corresponds to the second dual-polarized antenna module 12 and has the third polarized antenna 120, the fourth polarized antenna 122, and the third polarization port P3 and the fourth polarization port P4 corresponding thereto. The antenna control circuit 14 can be implemented in a form of a chip, and can be electrically connected to the first polarization port P1, the second polarization port P2, the third polarization port P3, and the fourth polarization port P4.

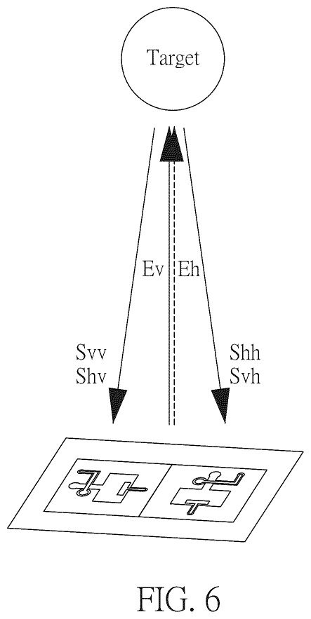

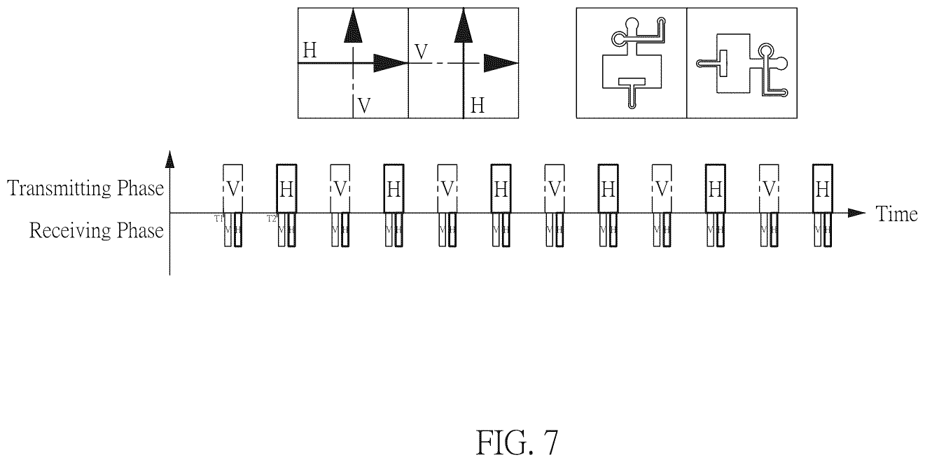

Reference is made to FIGS. 6 and 7. FIG. 6 is a schematic diagram of a monostatic radar configuration according to the first embodiment of the present disclosure, and FIG. 7 is a timing diagram showing an antenna control circuit controlling the full-polarimetric radar to transmit and receive signals in a time-divisionally duplexing manner according to the first embodiment of the present disclosure. In this embodiment, the first dual-polarized antenna module 10 and the second dual-polarized antenna module 12 can be disposed adjacent to each other as shown in FIG. 6 to form a monostatic radar configuration.

The antenna control circuit 14 can use two mutually orthogonal ones of the first polarized antenna 100, the second polarized antenna 102, the third polarized antenna 120, and the fourth polarized antenna 122 as transmitting antennas, and use another two mutually orthogonal ones as receiving antennas. For example, the first polarization port P1 and the third polarization port P3 can be used as signal receiving terminals, and the second polarization port P2 and the fourth polarization port P4 can be used as signal transmitting terminals.

Next, the antenna control circuit 14 can radiate a first transmitting signal and a second transmitting signal at a first time point T1 and a second time point T2 respectively through two mutually orthogonal transmitting antennas, and receive the first reflecting signal and the second reflecting signal corresponding to the first transmitting signal through two mutually orthogonal receiving antennas, and receive the third reflecting signal and the fourth reflecting signal corresponding to the second transmitting signal.

For example, as shown in FIG. 7, in a transmitting phase, vertical polarization signals V and horizontal polarization signals H can be periodically transmitted at different time points. For example, at the first time point T1 in one cycle, the horizontal polarization signal H is transmitted through the first polarized antenna 100 corresponding to the second polarization port P2, and at the second time point T2, the vertical polarization signal V is transmitted through the fourth polarized antenna 122 corresponding to the fourth polarization port P4. Energy of the vertical polarization signal V is represented by Ev, and energy of the horizontal polarization signal H is represented by Eh.

At the first time point T1, after the horizontal polarization signal H hits a target object and is reflected, the antenna control circuit 14 can receive the vertical polarization signal V generated by the reflection through the second polarized antenna 102 corresponding to the first polarization port P1, and receive the horizontal polarization signal H generated by the reflection through the third polarized antenna 120 corresponding to the third polarization port P3 in a receiving phase. Corresponding scattering parameters of the vertical polarization signal V and the horizontal polarization signal H are Svh and Shh, respectively.

At the second time point T2, after the vertical polarization signal V hits the target and is reflected, the antenna control circuit 14 can receive the vertical polarization signal V generated by the reflection through the second polarized antenna 102 corresponding to the first polarization port P1, and receive the horizontal polarization signal H generated by the reflection through the third polarized antenna 120 corresponding to the third polarization port P3. Corresponding scattering parameters of the vertical polarization signal V and the horizontal polarization signal H are Svv and Shv.

Therefore, detected reflecting energy Esv and Esh can be obtained by multiplying an incident energy by a scattering parameter matrix, as expressed by the following equation:

$$[ \begin{matrix}Esv \\ Esh\end{matrix} ] = [ \begin{matrix}Svv & Svh \\ Shv & Shh\end{matrix} ] [ \begin{matrix}Ev \\ Eh\end{matrix} ] .$$

It should be noted that the reflecting energy carries information of two polarization directions. Compared with the existing co-polarized radar, the obtained reflected energy Esv and Esh can more accurately describe characteristics of the target object and can even further be used to obtain surface morphology information of the target object.

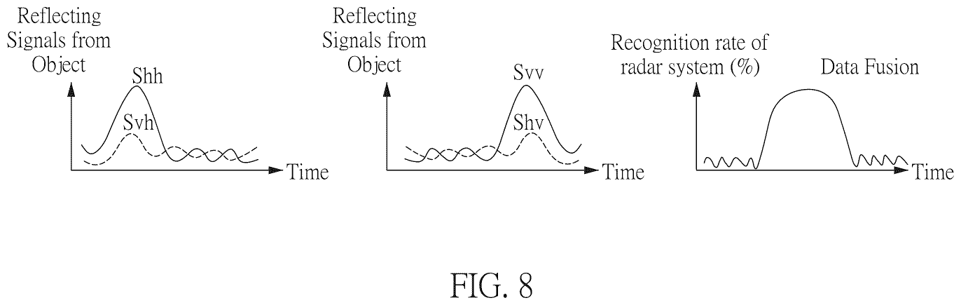

Referring to FIG. 8, FIG. 8 is a schematic diagram of signal processing performed by the antenna control circuit according to the first embodiment of the present disclosure. As shown in FIG. 8, the antenna control circuit 14 can obtain the scattering parameters Shh and Svh according to the first reflecting signal and the second reflecting signal, and generate the scattering parameters Svv and Shv according to the third reflecting signal and the fourth reflecting signal. Data of these scattering parameters can be fused to obtain a detection result.

In other words, by transmitting signals with polarization directions that are mutually orthogonal through a time-divisionally multiplexing manner, after being reflected by the target object, signals with two different polarization directions can be received in a single cycle. These signals can be fused in a signal processing stage to obtain a reflecting signal with complete information, thereby improving the recognition of targets when applied to various radar-related fields.

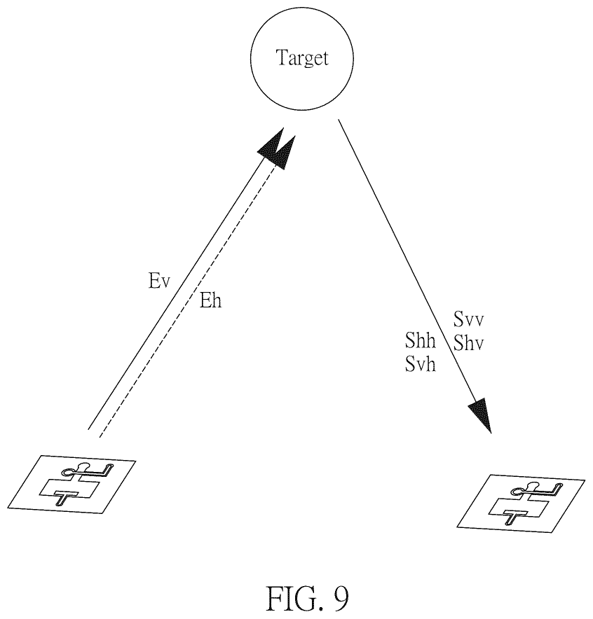

Furthermore, FIG. 9 is a schematic diagram of a bistatic radar configuration according to the first embodiment of the present disclosure. In some embodiments, in addition to disposing the first dual-polarized antenna module 10 and the second dual-polarized antenna module 12 at the same location to form a monostatic radar module with a two-transmit-two-receive architecture, the first dual-polarized antenna module 10 and the second dual-polarized antenna module 12 can also be disposed at different locations to form a bistatic radar module with a one-transmit-one-receive architecture as shown in FIG. 9. The first dual-polarized antenna module 10 and the second dual-polarized antenna module 12 are arranged to be separated from each other by a predetermined distance, and one of the first dual-polarized antenna module 10 and the second dual-polarized antenna module 12 serves as a receiving module.

### Second Embodiment

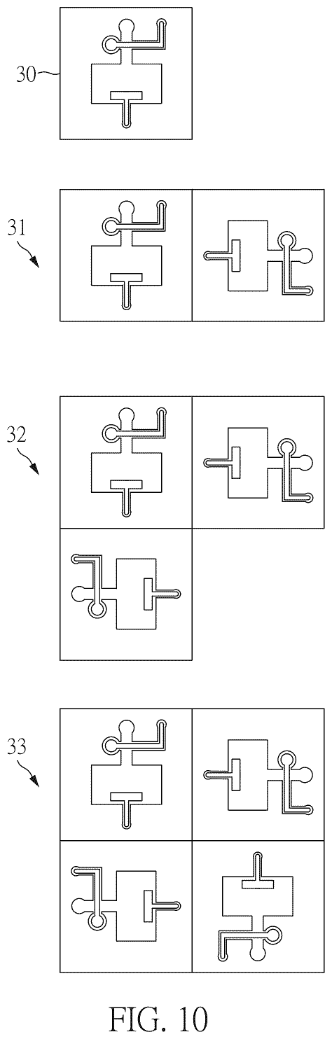

In a second embodiment, the present disclosure further provides a full-polarimetric radar, which can include two or more identical dual-polarized cavity-backed antenna modules but arranged in different directions. FIG. 10 is a configuration diagram of a full-polarimetric radar according to a second embodiment of the present disclosure. As shown in FIG. 10, a full-polarimetric radar 31 can include two dual-polarized cavity-backed antenna modules 30, a full-polarimetric radar 32 can include three dual-polarized cavity-backed antenna modules 30, and a full-polarimetric radar 33 can include four dual-polarized cavity-backed antenna modules 30. In addition, the full-polarimetric radars 31, 32, and 33 all include the antenna control circuit mentioned in the first embodiment, which is not specifically shown here. Furthermore, as a quantity of the dual-polarized cavity-backed antenna modules increases, a quantity of the antenna control circuits is not limited to one, and each antenna control circuit can be connected to different quantities of dual-polarized cavity-backed antenna modules according to user needs, thereby increasing a flexibility for radar system design.

In addition, in this embodiment, the antenna control circuit can control a feeding signal of each dual-polarized cavity-backed antenna to radiate different types of transmitting signals such as vertical polarization, horizontal polarization, positive 45-degree and negative 45-degree polarizations, right-hand circular polarization and left-hand circular polarization through the dual-polarized cavity-backed antenna modules 30. In addition to controlling the feeding signal through the antenna control circuit, an arrangement of the dual-polarized cavity-backed antenna modules 30 must also be matched.

Taking the full-polarimetric radar 31 as an example, two of the dual-polarized cavity-backed antenna module 30 can be arranged in directions perpendicular to each other, and the antenna control circuit can control the first polarized antenna to radiate a vertical polarization signal through the first polarization port (corresponding to the first feeding terminal) of one of the dual-polarized cavity-backed antenna modules 30, and control the second polarized antenna to radiate a horizontal polarization signal through the second polarization port (corresponding to the second feeding terminal) of the one of the dual-polarized cavity-backed antenna module 30 in-phase. At the same time, a reflecting signal generated by the vertical polarization signal and a reflecting signal generated by the horizontal polarization signal are received through the first polarized antenna and the second polarized antenna of another one of the dual-polarized cavity-backed antenna module 30. The time-sharing transmitting and receiving mechanism mentioned in the embodiment allows the full-polarimetric radar 31 to detect characteristics of a target object based on the reflecting signals corresponding to the vertical polarization signal and the horizontal polarization signal, respectively. In addition, the vertical polarization signal and the horizontal polarization signal are not limited to being generated from the same dual-polarized cavity-backed antenna module. As long as the polarized antennas are orthogonal to each other, they can be used to generate the vertical polarization signal and the horizontal polarization signal, respectively. At the time point of generating the vertical polarization signal or the horizontal polarization signal, a set of orthogonal polarized antennas that are not used to generate the transmitting signals can be used to receive the reflecting signals.

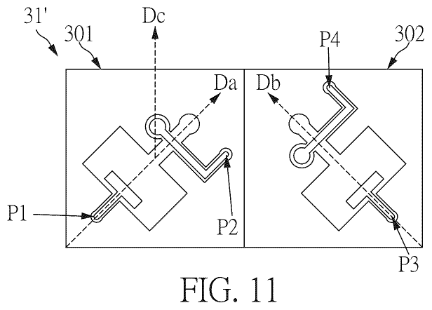

FIG. 11 is a schematic diagram of a configuration of a full-polarimetric radar for generating positive and negative 45-degree polarization signals according to the second embodiment of the present disclosure. Referring to FIG. 11, the full-polarimetric radar 31′ can include at least two dual-polarized cavity-backed antenna modules 301 and 302. The dual-polarized cavity-backed antenna module 301 can be tilted 45 degrees relative to a reference configuration direction Dc. More specifically, the dual-polarized cavity-backed antenna module 301 can be arranged, such that a direction Da along which the first strip-shaped slot and the second strip-shaped slot extend is inclined 45 degrees relative to the reference configuration direction Dc, and the dual-polarized cavity-backed antenna module 302 is symmetrically arranged with the dual-polarized cavity-backed antenna module 301. The dual-polarized cavity-backed antenna module 301 has a first polarization port P1 and a second polarization port P2, and the dual-polarized cavity-backed antenna module 302 has a third polarization port P3 and a fourth polarization port P4.

In this structure, the antenna control circuit can generate a first transmitting signal and a second transmitting signal through the first polarization port P1 and the second polarization port P2 of the dual-polarized cavity-backed antenna module 301, and the first transmitting signal and the second transmitting signal are a positive 45-degree polarization signal and a negative 45-degree polarization signal, respectively. At the same time, a reflecting signal corresponding to the positive 45-degree polarization signal and a reflecting signal corresponding to the negative 45-degree polarization signal can be received through the third polarization port P3 and the fourth polarization port P4 of the dual-polarized cavity-backed antenna module 302.

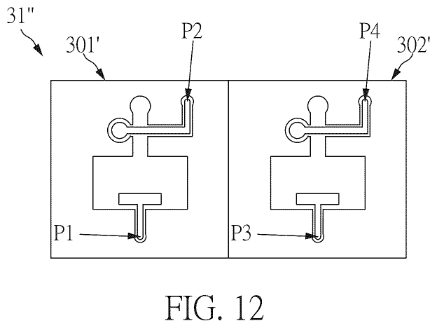

FIG. 12 is a schematic diagram of a configuration of a full-polarimetric radar for generating left-handed circular polarization signals and right-handed circular polarization signals according to the second embodiment of the present disclosure. Referring to FIG. 12, the full-polarimetric radar 31″ can include at least two dual-polarized cavity-backed antenna modules 301′ and 302′ arranged in the same direction. The dual-polarized cavity-backed antenna module 301′ has a first polarization port P1 and a second polarization port P2, and the dual-polarized cavity-backed antenna module 302′ has a third polarization port P3 and a fourth polarization port P4.

In this structure, the antenna control circuit can generate a first transmitting signal and a second transmitting signal through the first polarization port P1 and the second polarization port P2 of the dual-polarized cavity-backed antenna module 301′. Specifically, the antenna control circuit can provide two signals with the same energy and a 90-degree phase difference to the first polarization port P1 and the second polarization port P2, respectively, so as to excite circular polarization signals through two mutually orthogonal polarized antennas of the dual-polarized cavity-backed antenna module 301′. When the first polarization port P1 is delayed by 90 degrees in phase with respect to the second polarization port P2, a right-hand circular polarization signal can be generated. Conversely, when the second polarization port P2 is delayed by 90 degrees in phase with respect to the first polarization port P1, a left-hand circular polarization signal can be generated. Furthermore, a reflecting signal corresponding to the right-hand circular polarization signal and a reflecting signal corresponding to the left-hand circular polarization signal can be received through the third polarization port P3 and the fourth polarization port P4 of the dual-polarized cavity-backed antenna module 302′.

Therefore, through the structures of the full-polarimetric radars of FIGS. 10 to 12 above, reflecting energy with information of two polarization directions can be obtained. Compared with the existing co-polarized radar, the obtained reflecting energy can more accurately describe characteristics of the target object and can even further be used to obtain surface morphology information of the target object.

In addition, it is worth mentioning that the antenna control circuit in each embodiment of the present disclosure can include radio frequency front-end components, a digital signal processor, a signal modulation circuit, and a signal processing and analysis circuit. In addition, the antenna control circuit also includes a variety of functional circuits, such as low noise amplifiers (LNA), power amplifiers, mixers, and a transceiver system.

### Beneficial Effects of the Embodiments

Therefore, the dual-polarized antenna module provided by the present disclosure can select two mutually orthogonal signal feeding points as transmitting terminals and another two as the receiving terminals when transmitting and receiving signals. By transmitting signals with polarization directions that are mutually orthogonal through the time-divisionally multiplexing manner, after being reflected by the target object, signals with two different polarization directions can be received in a single cycle. These signals can be fused in a signal processing stage to obtain a reflecting signal with complete information, thereby improving the recognition of targets when applied to various radar-related fields.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A full-polarimetric radar, comprising:
a first dual-polarized antenna module including a first polarized antenna and a second polarized antenna, wherein the first polarized antenna has a first polarization port, the second polarized antenna has a second polarization port, and polarization directions of the first polarized antenna and the second polarized antenna are orthogonal to each other;
a second dual-polarized antenna module including a third polarized antenna and a fourth polarized antenna, wherein the third polarized antenna has a third polarization port, the fourth polarized antenna has a fourth polarization port, and polarization directions of the third polarized antenna and the fourth polarized antenna are orthogonal to each other;
an antenna control circuit electrically connected to the first polarization port, the second polarization port, the third polarization port, and the fourth polarization port, wherein the antenna control circuit is configured to:
control two mutually orthogonal ones of the first polarized antenna, the second polarized antenna, the third polarized antenna, and the fourth polarized antenna to radiate a first transmitting signal and a second transmitting signal that are mutually orthogonal at a first time point and a second time point, respectively;
receive a first reflecting signal and a second reflecting signal that correspond to the first transmitting signal, and a third reflecting signal and a fourth reflecting signal that correspond to the second transmitting signal through another two mutually orthogonal ones of the first polarized antenna, the second polarized antenna, the third polarized antenna, and the fourth polarized antenna; and
generate a detection result according to the first reflecting signal, the second reflecting signal, the third reflecting signal and the fourth reflecting signal.

2. The full-polarimetric radar according to claim 1, wherein the first dual-polarized antenna module and the second dual-polarized antenna module are each a dual-polarized cavity-backed antenna module that includes:
a first metal member having a first opening, a first strip-shaped slot, a second strip-shaped slot and a third strip-shaped slot, wherein the first strip-shaped slot and the second strip-shaped slot extend outwardly from two opposite sides of the first opening, and the third strip-shaped slot intersects with the first strip-shaped slot;
a T-shaped metal member including a main section and a branch section that are connected to each other, wherein the branch section is disposed in the second strip-shaped slot, and the branch section has a first feeding terminal;
a strip-shaped metal member disposed in the third strip-shaped slot, wherein a portion of the strip-shaped metal member is located at an intersection between the third strip-shaped slot and the first strip-shaped slot, and the strip-shaped metal member has a second feeding terminal;
a second metal member disposed below the first metal member, wherein the second metal member has a second opening and a fourth strip-shaped slot that correspond to the first opening and the first strip-shaped slot, respectively; and
a bottom metal member disposed below the second metal member, wherein the bottom metal member has two slots corresponding to the first feeding terminal and the second feeding terminal;
wherein the first metal member, the second metal member and the bottom metal member are grounded, and the first opening and the second opening jointly form a back cavity.

3. The full-polarimetric radar according to claim 2, wherein the dual-polarized cavity-backed antenna module is disposed on a circuit board, and the antenna control circuit is disposed between the circuit board and the dual-polarized cavity-backed antenna module.

4. The full-polarimetric radar according to claim 1, wherein the first dual-polarized antenna module and the second dual-polarized antenna module are arranged adjacent to each other to form a monostatic radar configuration.

5. The full-polarimetric radar according to claim 1, wherein the first dual-polarized antenna module and the second dual-polarized antenna module are separated by a predetermined distance to form a bistatic radar configuration, and one of the first dual-polarized antenna module and the second dual-polarized antenna module serves as a receiving module for receiving the first reflecting signal, the second reflecting signal, the third reflecting signal, and the fourth reflecting signal.

6. A full-polarimetric radar, comprising:
a plurality of dual-polarized antenna modules each including a first polarized antenna and a second polarized antenna, wherein the first polarized antenna has a first polarization port, the second polarized antenna has a second polarization port, and polarization directions of the first polarized antenna and the second polarized antenna are orthogonal to each other; and
at least one antenna control circuit electrically connected to the first polarization port and the second polarization port of each of the plurality of dual-polarized antenna modules, wherein the at least one antenna control circuit is configured to:
control the plurality of dual-polarized antenna modules to radiate a first transmitting signal and a second transmitting signal;
receive a first reflecting signal and a second reflecting signal that correspond to the first transmitting signal and a third reflected signal and a fourth reflected signal that correspond to the second transmitted signal through the plurality of dual-polarized antenna modules; and
generate a detection result according to the first reflecting signal, the second reflecting signal, the third reflecting signal and the fourth reflecting signal that are received.

7. The full-polarimetric radar according to claim 6, wherein each of the plurality of dual-polarized antenna modules is a dual-polarized cavity-backed antenna module that includes:
a first metal member having a first opening, a first strip-shaped slot, a second strip-shaped slot and a third strip-shaped slot, wherein the first strip-shaped slot and the second strip-shaped slot extend outwardly from two opposite sides of the first opening, and the third strip-shaped slot intersects with the first strip-shaped slot;
a T-shaped metal member including a main section and a branch section that are connected to each other, wherein the branch section is disposed in the second strip-shaped slot, and the branch section has a first feeding terminal;
a strip-shaped metal member disposed in the third strip-shaped slot, wherein a portion of the strip-shaped metal member is located at an intersection between the third strip-shaped slot and the first strip-shaped slot, and the strip-shaped metal member has a second feeding terminal;
a second metal member disposed below the first metal member, wherein the second metal member has a second opening and a fourth strip-shaped slot that correspond to the first opening and the first strip-shaped slot, respectively; and
a bottom metal member disposed below the second metal member, wherein the bottom metal member has two slots positionally corresponding to the first feeding terminal and the second feeding terminal;
wherein the first metal member, the second metal member and the bottom metal member are grounded, and the first opening and the second opening jointly form a back cavity.

8. The full-polarimetric radar according to claim 7, wherein a quantity of the plurality of dual-polarized antenna modules is at least two, and the first transmitting signal and the second transmitting signal are a vertical polarization signal and a horizontal polarization signal, respectively.

9. The full-polarimetric radar according to claim 7, wherein a quantity of the plurality of dual-polarized antenna modules is at least two, each of the dual-polarized antenna modules is inclined by 45 degrees relative to a reference configuration direction, and the first transmitting signal and the second transmitting signal are respectively a positive 45-degree polarization signal and a negative 45-degree polarization signal.

10. The full-polarimetric radar according to claim 7, wherein a quantity of the plurality of dual-polarized antenna modules is at least two, the first transmitting signal and the second transmitting signal are respectively a right-hand circular polarization signal and a left-hand circular polarization signal, and the right-hand circular polarization signal and the left-hand circular polarization signal are respectively radiated by the first polarized antenna and second polarized antenna that are mutually orthogonal to which the at least one antenna control circuit provides a same energy and a phase difference of 90 degrees.
